(19) United States
(12) Patent Application Publication
(10) Pub. No.: US 2019/0114638 A1
(43) Pub. Date: Apr. 18, 2019

(54) Ride Sharing User Verification System

(71) Applicant: Nakina Flores, Chicago Heights, IL (US)

(72) Inventor: Nakina Flores, Chicago Heights, IL (US)

(21) Appl. No.: 16/164,751

(22) Filed: Oct. 18, 2018

Related U.S. Application Data
(60) Provisional application No. 62/573,951, filed on Oct. 18, 2017.

(51) Int. Cl. G06Q 20/40; H04L 29/08; H04L 29/06; G06Q 10/02; G08G 1/00

(52) U.S. Cl. CPC G06Q 20/4014; H04L 67/306; G08G 1/202; G06Q 10/02; H04L 63/08

(57) ABSTRACT

A ride sharing user verification system for verifying parties of a ride share includes a first user device associated with a first user, a second user device associated with a second user, a controller in communication with the user devices, and a memory coupled to the controller, wherein the controller is configured to provide a first graphical user interface accessible through the first user device through which the first user selects a first visual display, provide a second graphical user interface accessible through the second user device, receive ride sharing data indicating that the first user is scheduled to provide transportation services to the second user, and transmit the first visual display to the second user device. The first visual display displayed on the second user device enables the first user to verify the second user as a party to the ride share.

### CROSS-REFERENCE TO RELATED APPLICATIONS

This application incorporates by reference and claims the benefit of priority to U.S. Provisional Application 62/573,951 filed on Oct. 18, 2017.

### BACKGROUND OF THE INVENTION

The present invention relates to the field of ride sharing. More specifically, this disclosure details a ride sharing passenger and driver verification system.

Ride sharing has become wildly popular in today's society. Applications such as Uber and Lyft enable a driver to share his automobile with others for monetary gain while also helping the environment and reducing congestion on crowded roadways. The enormous rise in usage has occurred in under a decade meaning that ride sharing is both wildly popular, but also still growing and changing.

With all growth comes growing pains and the ride sharing industry is no stranger to such difficulties. One of the most notable issues with ride sharing is the need to enter the vehicle of what is essentially a stranger. While ride sharing services perform background checks, photograph, and even fingerprint their drivers; there have been highly publicized instances of ride sharing passengers being duped by criminals pretending to be drivers for Uber, Lyft, etc. The dangers of entering a criminal's automobile are clear and present in the minds of most riders, a fact that has even been used by existing Taxi companies in an attempt to scare would be ride share users away from such services.

Criminals are able to easily trick passengers because there is no way to verify if the car, truck, etc. they are entering is really an official Uber, Lyft, etc. beyond taking the drivers word as fact. This lack of a system for verification of a driver and passenger (as passengers could be criminals as well) also presents less nefarious issues. It has become a common occurrence for ride sharing drivers to pick up the wrong passenger(s) due to the popularity of such services when adjourning from concerts, nightclubs, etc. For example, when young adults leave a bar at the end of the night, there is typically a crowd of people which forms outside the bar to chat, smoke, and/or hail cabs or ride sharing automobiles. It is not uncommon, even with basic information about the ride sharing car provided to the rider(s), for a rider to enter the wrong vehicle and be taken the wrong destination. Additionally, many times cab drivers mistakenly attempt to pick up ride sharing users who appear to be waving down a cab; further straining taxi/ride sharing relations.

Accordingly, there is a need for a ride sharing passenger and driver verification system.

### BRIEF SUMMARY OF THE INVENTION

To meet the needs described above and others, the present disclosure describes both systems and methods for ride sharing passenger and driver verification. More specifically, the present invention enables users to visually verify their ride sharing counterpart.

One embodiment of the present invention may be a mobile device (smartphone, tablets, etc.) application. This application, called “Spot Me” can be a standalone application or integrated with ride sharing applications such as Uber or Lyft. The application enables end users to visually verify their ride sharing counterparts via the hardware displays of their mobile devices. For example, in one embodiment of the present system, an end user may call an Uber and then activate Spot Me. The application will display a bright orange pattern which, when held out to passing traffic, will signal the Uber driver and also dissuade taxi drivers, etc. from stopping.

The example above is just one of many embodiments of the present invention. For added security, the present invention may also enable a passenger or driver to create a unique visual display which will be transmitted by the present invention to their corresponding ride sharing companion to ensure proper matching. For example, each Uber driver may come up with their own, unique, bright orange visual display which sets them apart from both other ride sharing services and also other Uber drivers. Such a unique visual display could be, in one instance, a cartoon rabbit. This orange cartoon rabbit, selected by the Uber driver, will be transmitted to their intended passenger. The waiting passenger can hold their phone up to oncoming traffic and the Uber driver will be able to quickly recognize their unique visual display. The driver can then also hold up their phone to the passenger (which also displays the orange cartoon rabbit) to enable quick, visual verification between the two ride sharing users.

The present invention can also be utilized outside of ride sharing. For example, the Spot Me application can be set up on a parent and child's mobile computing devices to enable the parent to spot their child on a crowded playground. The application can enable remote activation via unilateral action meaning only the parental user need activate the Spot Me application, which will activate on the child's device without input needed from the child. Other examples could include emergency or healthcare workers utilizing Spot Me to activate a visual display on an elderly person's smartphone if he is in need of rescue. One a brighter note, the application can also be utilized by friends at a concert in order to locate one another amongst a large crowd.

A goal of the present invention is to enable quick and easy visual verification of others in various social settings. Ride sharing requires passengers to get into a stranger's car and vice versa. The present system provides these participants a basic, yet extremely effective system and method for ensuring the person they are interacting with is who they say they are. This combined with background checks, photographing, and finger printing ensure that ride sharing users will enter the appropriate vehicle without the fear of being the victim of a crime.

An advantage of the present system is that it enables verification through the most basic yet efficient manner possible. There is an old adage that a picture is worth a thousand words. This wisdom holds up as the present system enables a ride sharing driver and passenger to verify one another in an instant without having to speak a single word. This functionality can also be useful for those who speak different languages as it is much easier to look for, as an example, a bright red logo on a smartphone rather than verify a driver's license plate, name, etc.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic diagram of the components of a ride sharing user verification system of the present application.

FIGS. 2 and 3 are diagrams of the ride sharing user verification system of FIG. 1 in use.

FIGS. 4 and 5 are example visual displays of the ride sharing user verification system of FIG. 1.

### DETAILED DESCRIPTION OF THE INVENTION

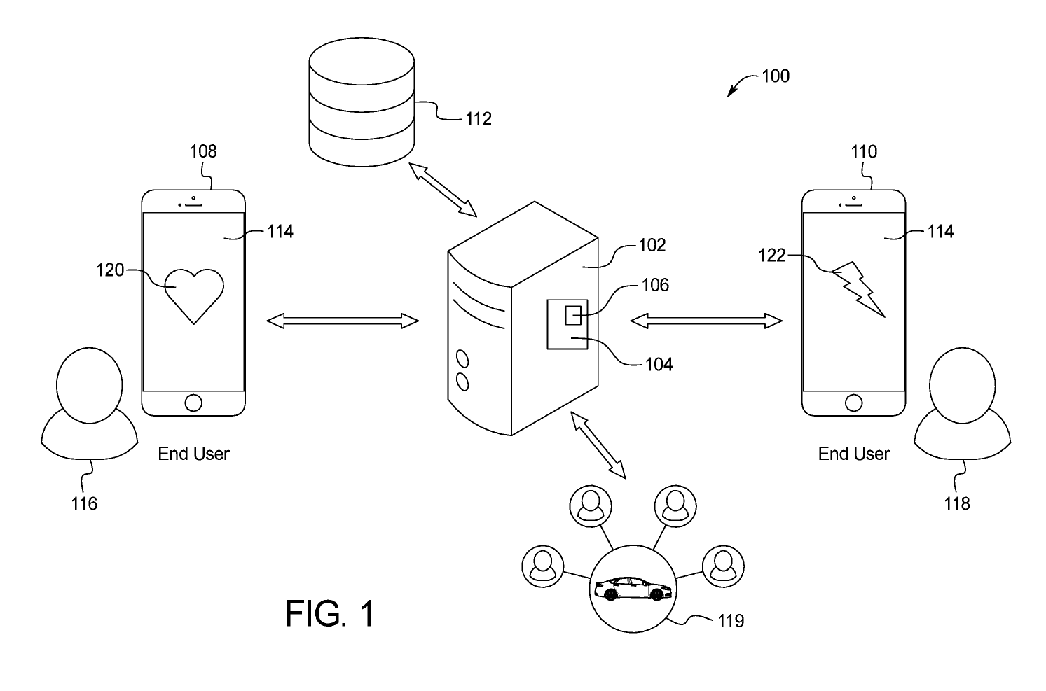

FIG. 1 is an example schematic representation of a ride sharing verification system 100 of the present application. In the example shown in FIG. 1, the ride sharing verification system 100 includes a centralized server 102 including one or more controllers 104 and memory 106. The server 102 may be one or more physical servers, a distributed server hosting solution, or cloud based, and is in communication with at least a first user device 108 and a second user device 110 through a wired or wireless system. A database 112 used in communication with the controller 104 stores data such as a plurality of visual displays as well as a plurality of user profiles associated with users of the system.

The system 100 may include a mobile device application 114 that may be installed on devices 108, 110 of first and second users 116, 118 that permits the first and second users 116, 118 to access and display select visual images 120, 122.

The features and functions of the system 100 are provided to users 116, 118 through one or more graphical user interfaces (GUIs). The GUIs are accessed by the users through the one or more end user devices 108, 110. Example end user devices 108, 110 include smartphones, tablets, laptops, personal computers, kiosks, etc. In a typical embodiment, the one or more programs providing the GUIs to the users 116, 118 are hosted in the server 102 that, when executed, cause the one or more controllers 104 to perform the various functions described herein. The memory 104 is configured to store program instructions executable by the controller 106. It is understood that the specific structure described above is merely one example of a structure that may be used to host and deploy the system 100.

The system 100 enables each user 116, 118 to create a user profile through a GUI on the respective user device 108, 110. In one embodiment, each user selects a visual display 120, 122 that is associated with the user's user profile. Ride sharing data is communicated to the controller 106 by direct input from the first and/or second user 116, 118 or through a transportation company 119 that is registered with the system 100. The ride sharing data includes an indication that the first user 116 is scheduled to provide transportation services to the second user 118. Once the ride sharing data is received, the system transmits the visual display 120 associated with the first user 116 to the second user device 118. The visual display 120 may be displayed on the second user device 118 through any displaying means, such as on the GUI of the second user device 118, through text message, or as a push notification on the second user device 118.

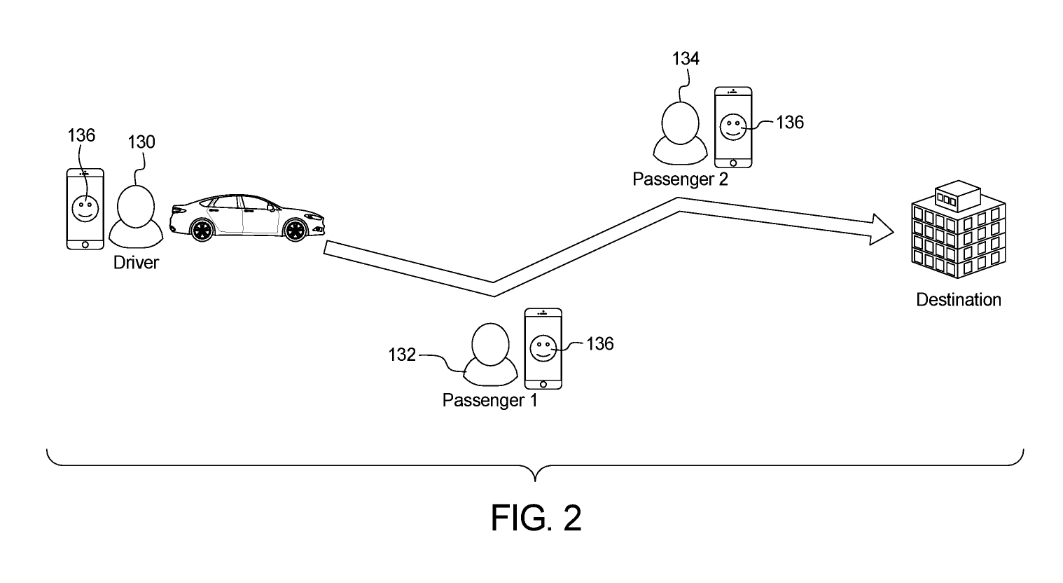

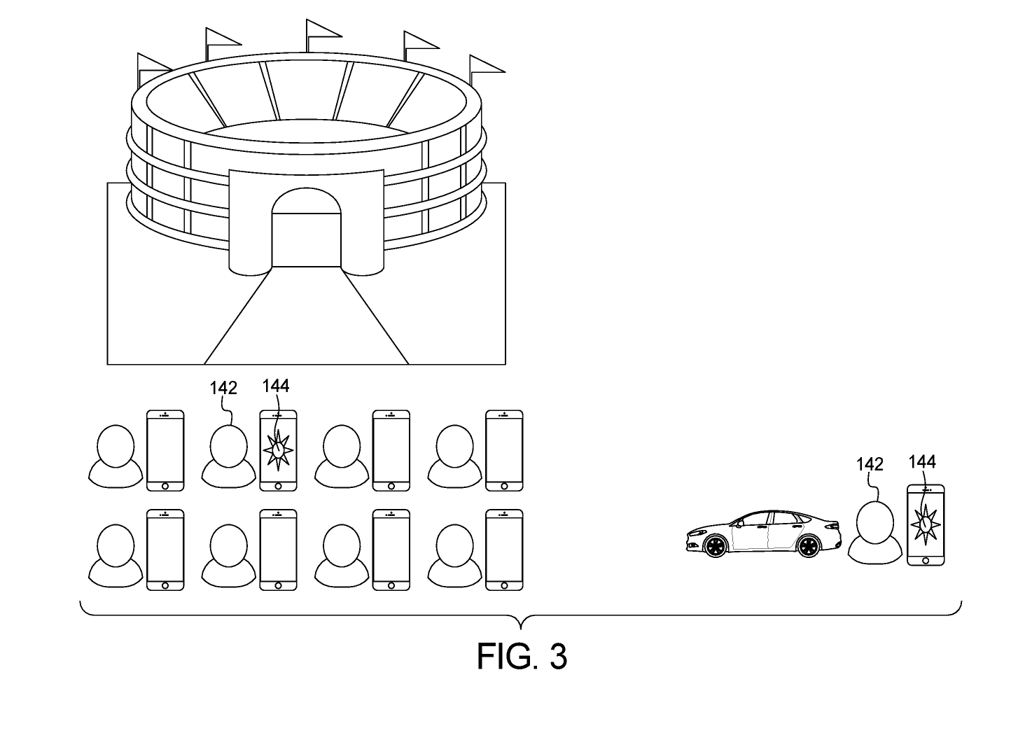

Referring to FIG. 2, the ride sharing user verification system 100 enables a driver 130 and his passengers 132, 134 to verify their scheduled services using the visual display 136. In this example, the driver 130, or the first user, has selected a smiley face as his unique visual display 136 for verification. When the system 100 receives the ride sharing data, the visual display 136 is transmitted to the passengers 132, 134, the second user and the third user. As the first user 130 approaches the pick-up location for each passenger, both the driver 130 and the passenger 132, 134 present the visual display 136 on the respective user device to enable visual recognition and verification. In the example shown, the driver 130 is picking up multiple passengers 132, 134, each having received the same smiley face visual display 136 to enable verification of all parties involved in the ride share. In the embodiment shown in FIG. 3, a driver 140 is picking up a passenger 142 at a crowded location, such as a stadium. The driver 140 and passenger 142 display the visual display 144 on their respective user devices to verify the parties to the ride share.

In a further embodiment, the ride sharing user verification system 100 may transmit the visual displays 120, 122 of each user 116, 118 to the other user's user device 110, 108, respectively, in order to verify the parties of the ride share, instead of simply sharing the visual display of the first user. For example, the first user 116 may select a first visual display 120, such as a yellow heart, in connection with her profile, while the second user 118 selects a second visual display 122, such as a red lightning bolt. Upon receipt of the ride sharing data, the system 100 transmits the first visual display 120 to the second user device 110 and the second visual display 122 to the first user device 108. When the driver (first user 116) reaches the pick-up location, she will look for a passenger (second user 118) holding a user device 110 displaying the driver's yellow heart image 120, while the passenger (second user 118) will look for a driver (first user 116) holding a user device 108 displaying the passenger's yellow heart image 122.

It should be noted the smiley face, lightning bolt, and heart are examples of the visual display which may be utilized by the present system. Other visual displays may include images, graphics, numbers, letters, animations, moving images, etc. The visual display may also utilize a mobile device's camera flash, multiple hardware displays of a given device, or even displays across multiple end user devices of a single user (e.g., smartphone and smartwatch). The visual display may also be synced to music or sounds to further enhance recognition by end users or even flash a coded message (e.g., Morse code).

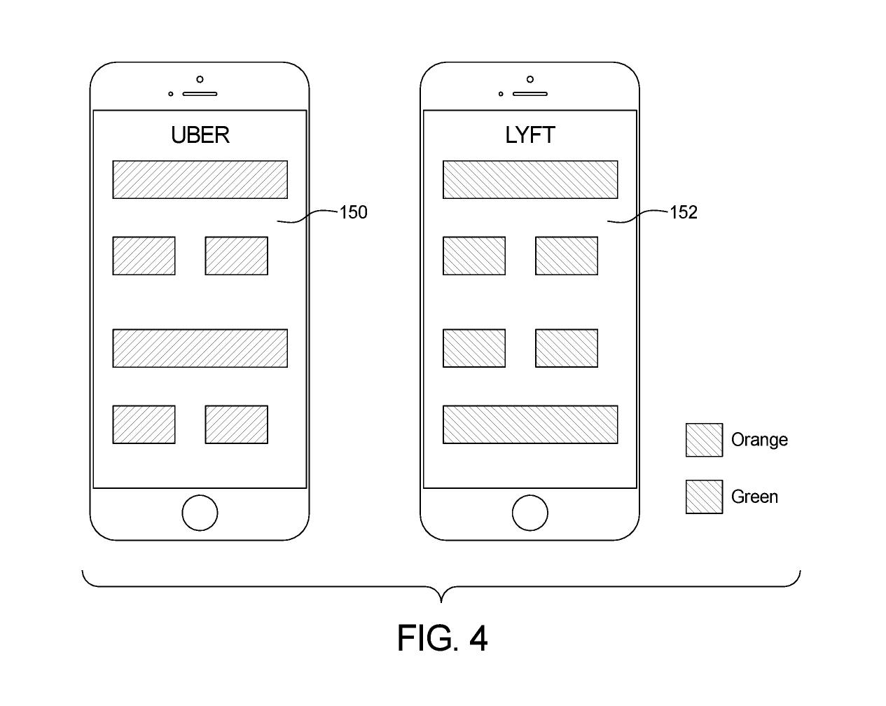

In a further embodiment of the present invention, the system 100 may include visual displays specific to a transportation service company such as Uber or Lyft. In one embodiment, the user may note his association with the transportation service company when creating the user profile or, in other embodiments, the transportation service company may be registered with and maintain a list of drivers associated therewith within the ride sharing user verification system 100. The visual display 120, 122 of each user 116, 118 associated with the transportation service company may include a design or portion of the user's visual display that is associated with the transportation service company. For example, FIG. 4 illustrates example visual displays 150, 152 that may be associated Uber and Lyft, respectively. The visual display 150 includes a number of orange bars while the visual display 152 includes a number of green bars. In one embodiment, the passenger can order a ride share from a transportation service company and then activate the ride sharing user verification system 100 to display the general “Uber” visual display 152.

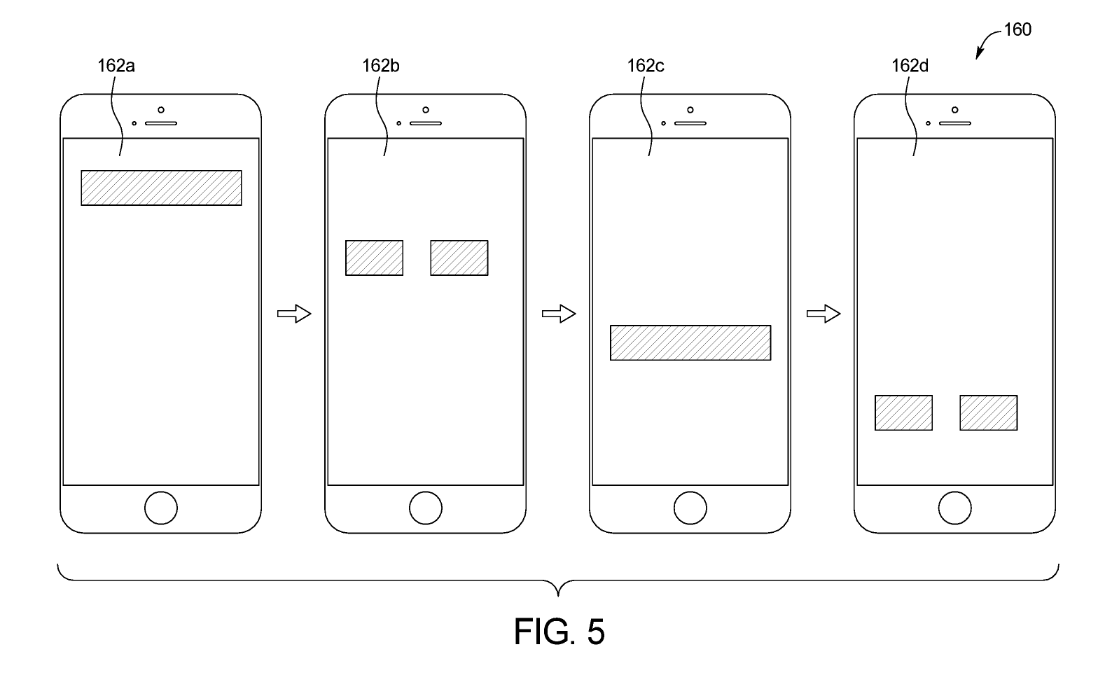

FIG. 5 is schematic representation of a visual display including an animation feature. The visual display 160 may include flashing designs, such as a bar changing shape as it moves down the screen in a series of four GUIs 162a-162d of a user device. The flashing may also include a coded message. The flashing of images helps catch another user's attention and also prevents third parties from easily replicating the verifying visual display.

In a further embodiment, the system 100 may allow an end user 118 to signal a taxi instead of a ride sharing service by setting the GUI on his user device 110 to a visual display specific to cab drivers. In this example, the cab driver visual display may be a full yellow screen, a color associated with taxi cabs and extremely visible to passing traffic.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A ride sharing user verification system for verifying parties of a ride share comprising:
a first user device associated with a first user;
a second user device associated with a second user;
a controller in communication with the one or more user devices;
a memory coupled to the controller, wherein the memory is configured to store program instructions executable by the controller;
wherein in response to executing the program instructions, the controller is configured to:
provide a first graphical user interface accessible through the first user device through which the first user creates a first user profile and selects a first visual display associated with the first user profile;
provide a second graphical user interface accessible through the second user device through which the second user creates a second user profile;
receive ride sharing data indicating that the first user is scheduled to provide transportation services to the second user; and
transmit the first visual display to the second user device;
wherein the first visual display displayed on the second user device enables the first user to verify the second user as a party to the ride share.

2. The ride sharing user verification system of claim 1, wherein the step of transmitting the first visual display is displaying the first visual display on the second graphical user interface.

3. The ride sharing user verification system of claim 1, wherein the step of transmitting the first visual display is sending the first visual display via text message.

4. The ride sharing user verification system of claim 1, the step of providing a second graphical user interface includes the step of providing a second graphical user interface accessible through the second user device through which the second user creates a second user profile and selects a second visual display associated with the second user profile.

5. The ride sharing user verification system of claim 4, wherein the controller is further configured to:
transmit the second visual display to the graphical user interface of the first user device.

6. The ride sharing user verification system of claim 1, wherein the first user is a driver associated with a transportation service company, wherein the second user is a passenger client of the transportation service company, and wherein the first visual display includes a pre-defined pattern associated with the transportation company.

7. The ride sharing user verification system of claim 1, wherein the first visual display includes a coded message.

8. A method of verifying parties to a ride share comprising the steps of:
providing a graphical user interface accessible through a user device through which a user creates a user profile and selects a visual display associated with the user profile;
receiving ride sharing data indicating that the user is scheduled to provide transportation services to a further user;
transmitting the visual display to a further user device of the further user; and
recognizing the visual display on the further user device to verify the further user as a party to the ride share.

9. The method of claim 8, further comprising the steps of:
providing a further graphical user interface accessible through the further user device through which the further user creates a further user profile and selects a further visual display associated with the further user profile;
transmitting the further visual display to the user device;
displaying the further visual display on the user device to enable the user and the further user to verify each other as parties to the ride share.

10. A method of verifying parties to a ride share comprising the steps of:
providing a graphical user interface accessible through a user device through which a user creates a user profile;
receiving ride sharing data indicating that the user is scheduled to receive transportation services from a further user;
receiving a further visual display associated with the further user on the user device of the user;
displaying the further visual display on the user device to verify the further user as a party to the ride share.
